(19) United States
(12) Patent Application Publication
(10) Pub. No.: US 2013/0318558 A1
(43) Pub. Date: Nov. 28, 2013

(54) INDOOR BROADCASTING METHOD AND SYSTEM

(71) Applicant: Andreas Sieber, Kirchheim (DE)

(72) Inventor: Andreas Sieber, Kirchheim (DE)

(73) Assignee: INSTITUT FUR RUNDFUNKTECHNIK GMBH, Munchen (DE)

(21) Appl. No.: 13/980,550

(22) PCT Filed: Jan. 24, 2011
(86) PCT No.: PCT/EP2011/050891

§ 371 Date: Aug. 13, 2013

(51) Int. Cl. H04N 21/61

(52) U.S. Cl. CPC H04N 21/6156
USPC 725/74

(57) ABSTRACT

A method for distributing broadcast signals to an indoor environment, includes the steps of receiving (1000) the broadcast signals (7); transforming (1002) the received broadcast signals (7) into electric signals by use of a Power Line Communication device (8); transmitting (1004) the electric signals over power lines (80), wherein the electric signals are modulated, and configured to be irradiated (1006) as aerial signals (82) in the surrounding space of the power lines (80) of the indoor environment, and wherein the irradiated aerial signals (82) are adapted to be received (1008) with a receiver (31, 32, 33, 41, 42, 43, 51, 61, 62, 63), and the receiver (31, 32, 33, 41, 42, 43, 51, 61, 62, 63) is adapted to demodulate the received irradiated aerial signals (82). Corresponding systems, Power Line Communication devices and methods carried out by the device are also provided.

### TECHNICAL FIELD

The present invention relates to a method and a system for distributing broadcast signals adapted to provide good reception in so called “indoor” environments. It also relates to a corresponding Power Line Communication device and to a method implemented by said device.

### BACKGROUND ART

Devices and methods for transmitting broadcast signals, such as television (TV) or radio signals are well known.

Existing techniques usually include an antenna for receiving radio waves transmitted through the air for converting them in electrical signals, that are then decoded and processed by a processor, typically a microcontroller.

Since walls and obstacles in general, placed through the broadcasting path, may attenuate the signal, receivers (like TV sets or set-top-boxes) are usually connected to external antennas (aerials, dishes, or other) placed on the roof of the buildings or any other exposed area. Broadcast signals received through these antennas are then transmitted to the indoor receivers via a transmission line, typically a coaxial cable, which runs along or within the walls of the buildings. Receivers are connected to this line through an external patch cable (e.g. a coaxial cable) that is connected between the receiver input connector and a plug provided in the wall and connected to the transmission line.

Yet an antenna cable might not be available in every room as illustrated with reference to FIG. 1 that schematically represents a building 101 according with the prior art. The building 101 comprises four rooms respectively designated by the numerical references 1, 2, 3 and 4. The building 101 also comprises a traditional system for indoor distribution of broadcast signals comprising an aerial antenna 5 of a conventional type adapted for receiving television signal waves and a transmission line 6. In the example described, the transmission line 6 comprises a plurality of coaxial cables connected to the antenna 5, and therefore referred to as antenna cables 6 in the following. These antenna cables 6 connect the aerial antenna 5 to a certain number of plugs (not shown) inside the building, to which receivers can be connected through patch cords. In the example of FIG. 1, only rooms 1, 2 and 4 are provided with plugs for connection to antenna cables 6, while room 3 is not. In the building 101 three receivers such as television sets are present. Televisions 11 and 12 are connected to the antenna cable 6, and therefore have a similar reception quality that is generally assumed to be good if there is no disturbance on the antenna cables 6. On the other hand, a television 13 is located in room 3 and cannot be connected to the antenna cables 6. Therefore, in order to receive broadcast signals, the television 13 must be connected with a local antenna such as a portable antenna of foldable type. The quality of the reception of such a local antenna depends on the strength of the aerial broadcast signal inside of room 3. Usually, the quality of such reception is poor, leading to a situation where the television 13 is not able to receive in a satisfactory manner part or all of the TV channels.

To overcome such situations, repeaters are conventionally used to provide reception to receivers scattered in an environment where the reception of aerial broadcast signals is not possible. These repeaters are also known as “gap fillers” as they repeat a received television signal, for example in an indoor environment, therefore filling a coverage gap in the indoor environment.

Gap fillers allow extending the area for positioning of the receivers. Yet this requires the installation of a number of additional repeaters increasing in proportion with the coverage area. It also requires re-arranging the repeaters every time the setup of the receivers is changed.

As an alternative, it is also known to distribute the broadcast signals by using the existing power lines of a building. This is usually referred to as “Power Line Communication” or “Power Line Carrier”, in short “PLC”. This technology allows data such as computer signals to be transferred over the power lines. Nowadays it is known to use a PLC gateway for connecting the power lines of the building to an external network, like the Internet; this PLC gateway receives data through the external network and transmits them over the power lines inside the building.

Receivers inside the building such as computer receive these data via a suitable PLC device connected to an electric plug. Each PLC device decodes the signals transmitted on the power lines of the building and converts them in a different format. A PLC device for transmission of TV signals on power lines is described in patent JP2007228575 (A).

FIG. 2 schematically represents an existing system for distributing broadcast signals using a PLC infrastructure. The building 102 does not comprise an aerial antenna, and the television signals are obtained from a different source 171, such as a cable network.

In all the Figures referred to by the present description, a solid thick line identifies an electrical connection of a power line, while a thin dashed line identifies a cable, preferably a coaxial cable, for the transmission of television signals of known type, such as antenna cables.

With reference to FIG. 2, in order to distribute the broadcast signals inside the building 102, a known power line communication system 180 (or PLC) is used. The PLC 180 transmits data over the building's power lines 80. The power lines 80 are powered by the main power lines 90, carrying electrical power to the proximity of the building 102 trough the electric cables 91, and distributed after the electricity meter 92. The PLC 180 is adapted to receive through a connection 170 a broadcast signal such as the signal from the source 171. The PLC 180 is also adapted to convert the received broadcast signal into a signal 181 to be distributed over the wiring system of the power lines 80 inside the building 102.

The signal distributed by PLC 180 over the power lines 80 can reach every electric plug of the building 102, in all rooms 1, 2, 3 and 4. Each television 21, 22 and 23 that is connected to the power lines 80 is provided with an end-of-line PLC device 26 that receives the signals. Advantageously, the televisions are also provided with a transmodulator 25 that tunes the frequency of the distributed electric signals to frequencies corresponding to the input frequencies of the receivers of televisions 21, 22 and 23.

Therefore, by using a main PLC device 180 for the building 102 and a PLC device 26 for each television set 21, 22 and 23, the broadcasting signals can be distributed in the environment trough the wiring system of the power lines 80.

Similarly to systems using repeaters, PLC systems also require a dedicated PLC device for receiver with the same drawbacks as mentioned earlier.

As described above, the methods underlying the solutions described with reference to FIGS. 1 and 2 present the drawback of requiring, for each receiver, either a connection to the antenna cables 6 or to a dedicated PLC receiver 26 (if a main PLC device 180 is provided on the power lines).

Whenever a room is not provided with either one of these means, portable antennas such as the one of television 13 are the only possibility left, although they represent a not desirable alternative, because of the reception issues mentioned above.

Overall, the known systems for distributing aerial broadcast signals, have the drawback of requiring an important number of devices and of limiting the flexibility of placing or moving receivers in an environment.

### SUMMARY OF THE INVENTION

It is an object of the present invention to provide an improved method and a system for distributing broadcast signals to an indoor environment, that at least partially overcome the drawbacks of the existing techniques.

In particular, it is an object of the present invention to provide a method for distributing broadcast signals that improves the reception for all the receivers in an indoor environment.

It is a further object of the present invention to provide a method for distributing broadcast signals capable of operating with existing receivers, without the need of dedicated additional devices for each receiver.

It is a further object of the present invention to provide a method for indoor broadcasting that improves the flexibility of the infrastructure for distributing broadcast signals to receivers placed within an indoor or large environment.

These and further objects of the present invention are achieved by a method for distributing broadcast signals in an indoor environment, by a corresponding system, by a Power Line Communication device and by a method implemented by said device, incorporating the features of the annexed claims, which form integral part of the present description.

According to the present invention, the method for indoor broadcasting comprises the steps of: receiving broadcast signals, transforming the received broadcast signals into modulated electric signals using a Power Line Communication device, transmitting the modulated electric signals over power lines wherein the modulated electric signals are configured to be irradiated as aerial signals in the surroundings within the indoor environment, and the irradiated aerial signals are adapted to be received with a receiver and demodulated.

Preferably, the irradiated aerial signals propagate over the same frequencies of the received broadcast signals, or otherwise over available frequencies that are not occupied by the frequencies of other broadcast signals. Advantageously, this provides for an improved reception of the irradiated aerial signals.

Preferably, the irradiated aerial signals are either received trough portable antennas provided in the proximity of the receiver, for example of foldable antennas type, or are received trough portions of antenna cables running to the receiver.

### BRIEF DESCRIPTION OF THE DRAWINGS

Further features and advantages of the present invention will become apparent in the detailed description of a preferred non-exclusive embodiment of a method and a system for distributing broadcast signals according to the invention, which is described as a non-limiting example with the help of the annexed drawings, wherein:

FIG. 1, already described before, represents an example of a known system for transmission of broadcasts signals using an aerial antenna and cables within a building;

FIG. 2, already described before, represents an example of a known system for transmission of broadcasts signals using power line communication (PLC);

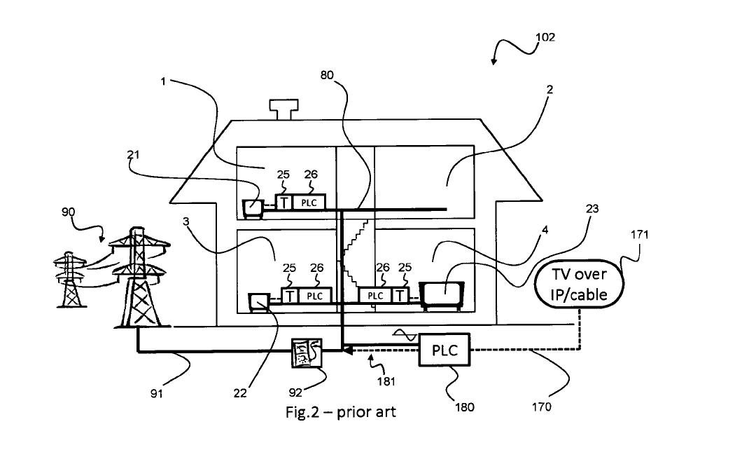

FIG. 3 represents an environment for carrying out an embodiment of the method for transmission of broadcasts signals in a building, according to the present invention;

FIG. 4 represents a flow chart of the method of the invention as carried out in the embodiment of FIG. 3;

FIG. 5 represents an environment for carrying out another embodiment of the method for transmission of broadcasts signals in a building, according to the present invention;

FIG. 6 represents a detailed example of an embodiment of the method according to the present invention, associated to a TV set;

FIG. 7 represents an environment for carrying out another embodiment of the method for transmission of broadcasts signals in a building, according to the present invention;

FIG. 8 represents an environment for carrying out another embodiment of the method for transmission of broadcasts signals in a building, according to the present invention.

These drawings illustrate different aspects and embodiments of the present invention and, where appropriate, like structures, components, materials and/or elements in different figures are indicated by the same reference numbers.

### DETAILED DESCRIPTION OF EMBODIMENTS

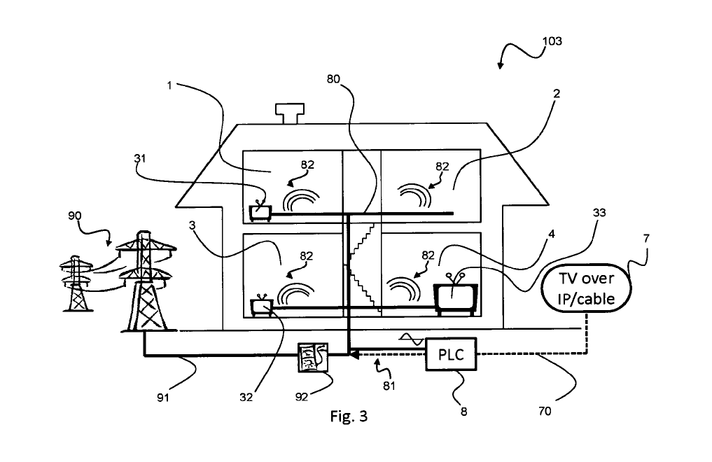

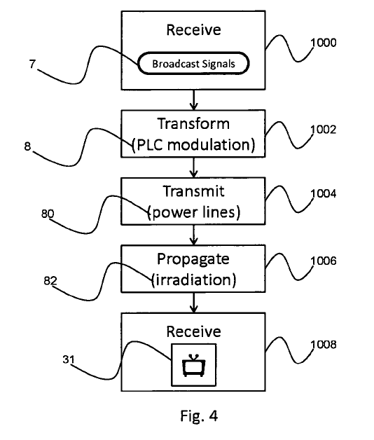

With reference to FIGS. 3 and 4, an embodiment of the invention will now be described.

FIG. 3 schematically represents a building 103, in which transmission of broadcast signals is achieved through an embodiment of the method according to the present invention represented as a flow chart in FIG. 4.

The method starts by a reception 1000 of the broadcast signals from a signal source 7. In the example, the broadcast signals represents a television signal and are delivered using the Internet Protocol (IP) and conventional cable means.

The broadcast signals are received trough a connection 70 to a PLC device 8. As an example, PLC 8 can be connected to a remote server via the Internet and retrieve the broadcast signals inside the building; such signals can be video or audio content, TV programs, data etc . . . PLC 8 can be controlled via a client computer connected to the mains of the building, or can be programmed during manufacturing so as to connect always to the same web server distributing TV or video content.

The PLC device 8 is adapted to modulate an electric current over the power lines 80 of the building in order to distribute the signals. The method comprises then a modulation 1002 of the received broadcast signals and a transmission 1004 of the modulated electric signals over the power lines 80 by the PLC 8.

In the present description, the term “indoor” is used to indicate a place wherein distribution of broadcast signals transmitted through the air to the whole environment is inefficient, and wherein power lines are available. Therefore, a clear example of an “indoor” environment is a building, with several thick walls, such as a house. Nonetheless, the application of the present invention can be hypothetically foreseen for several kinds of “indoor” environments, such as tunnels, garages, ships, natural caves, and so on.

In the described example, the PLC device 8 preferably uses OFDM (Orthogonal frequency-division multiplexing) or C-OFDM (coded OFDM) modulation schemes, and is adapted to transmit broadcast signals over the power lines 80 in the indoor environment of the building 103. Preferably, the broadcast signals can be DVB (Digital Video Broadcasting) services, such as DVB-T, DVB-T2 (terrestrial DVB) or DVB-C2 (cable DVB). The broadcast signals transmitted by the PLC device 8 are not limited to these, and may include also DAB (Digital Audio Broadcasting), DMB (Digital Multimedia Broadcasting) or DRM (Digital Radio Mondiale) or others. In a preferred embodiment, the PLC device 8 transmits up to 300 MHz and modulates in C-OFDM with up to 1024 QAM.

According to the invention, the modulation 1002 and the transmission 1004 are adapted so that the modulated electric signals are irradiated in the surroundings of the power lines 80 because of electromagnetic effects. Therefore, the method comprises a propagation 1006 of irradiated aerial signals 82 corresponding to the modulated electric signals in the areas in the vicinity of the power lines 80. In this case, rooms 1, 2, 3 and 4 are covered by the irradiated aerial signals 82.

According to the present invention, the irradiated aerial signals 82 are received by commercially available receivers during a reception 1008. Advantageously, the irradiated aerial signals carry all the information of the broadcast signals obtained by the signal source 7.

The irradiated aerial signals 82 have a sufficient strength to be received by televisions 31, 32 and 33 located in the building 103, trough portable antennas connected to the televisions.

With the usual PLC power levels, the indoor coverage is about 30 meters from the power lines 80. The power transmitted by the PCL 8 in the power lines 80 and therefore radiated in the environment is typically between −10 dBm and −30 dBm (where [dBm] indicates the power ratio in decibels [dB] of the measured power referenced to one milliwatt [mW]). Also, a Set-top-box operating in accordance with DVB-T standards is able to perform an error free reception of C-OFDM modulated signals up to a fading level of about −60 dBm. Accordingly, the power level of the irradiated aerial signals according to the invention is appropriate for reception by existing receivers, without need for additional devices.

Therefore, only one PLC device 8 operating in accordance with the method of the invention is needed to cover the whole building 103 providing reception to all receivers within range from the power lines 80.

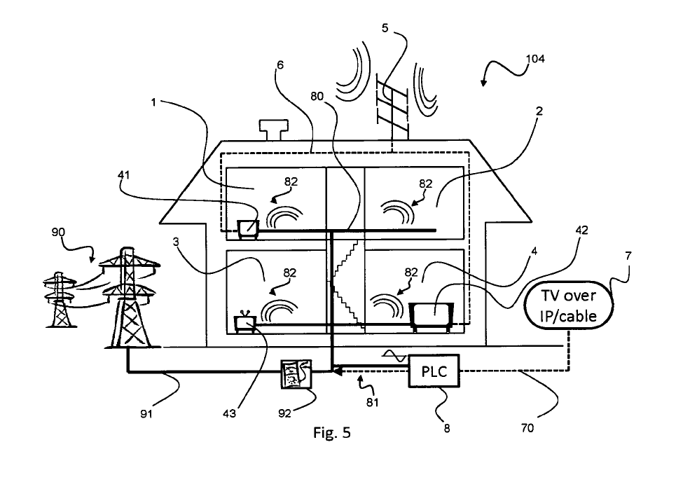

FIG. 5 schematically represents a building 104, in which reception of broadcast signals is achieved through another embodiment of the method according to the present invention.

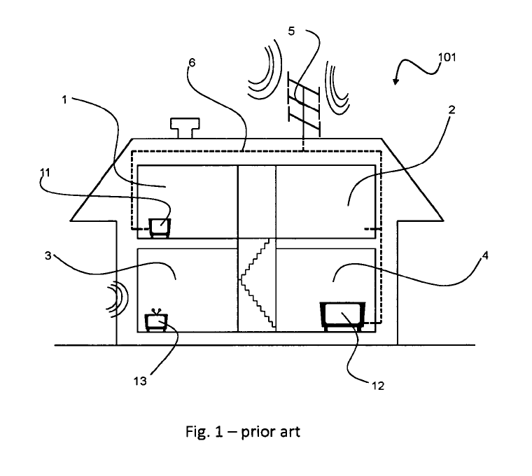

The building 104 comprises an aerial antenna 5, and a plurality of antenna cables 6 running through the rooms 1, 2, 3 and 4, corresponding to the configuration exemplified in FIG. 1. In addition, building 104 comprises a PLC 8 adapted to modulate an electric current over the power lines 80 in order to transmit data.

As already described with reference to FIGS. 3 and 4, television 43 located in room 3 receives the irradiated aerial signals 82 trough a portable local antenna with a good quality, depending on the shielding of the power lines 80 in this area. In a conventional manner, the portable antenna will also receive the aerial broadcast signals with a quality depending on the penetration of air waves in the building.

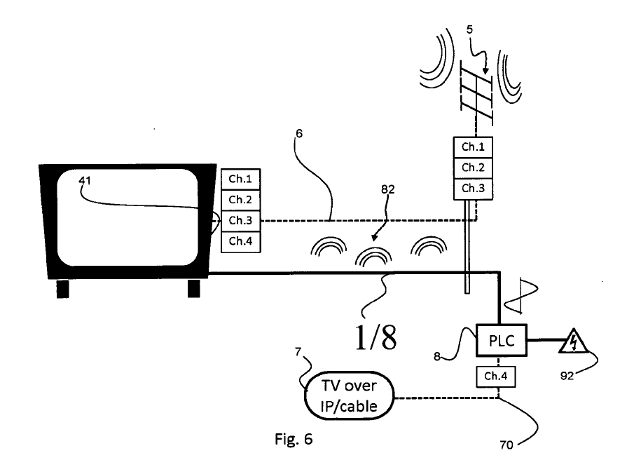

Televisions 41 and 42, respectively in room 1 and 4, are configured for receiving the aerial broadcast signals received trough the fixed antenna 5 and the antenna cables 6. Televisions 41 and 41 are not provided with a foldable antenna and cannot directly receive the irradiated aerial signals 82. Yet, the propagation of irradiated aerial signals 82 according to the method of the invention results in the generation of induced signals by the reception of the irradiated aerial signals 82 over the portions of antenna cables 6 running in the rooms 1 and 4 and the patch cords connected to them. Depending on their shielding, those antenna cables 6 are adapted to act as antennas for the irradiated aerial signals 82. In fact, their length is exposed to the irradiated aerial signals 82 that are captured. Therefore, televisions 41 and 42 are able to receive the broadcast signals of the source 7 by using the induced signals. FIG. 6 represents an example of a system for distributing broadcast signals embodying the present invention, associated to a TV set 41.

The receiver of television 41 is connected through the antenna cables 6 to the antenna 5, receiving a plurality of aerial broadcast signals corresponding to various TV channels, for example channels Ch. 1, Ch. 2 and Ch. 3. A patch cord may be provided connecting the TV set 51 to a wall plug; these means are not represented for sake of simplicity.

According to the present invention, the PLC 8 is connected to the power lines 80 that receive electric power by conventional electric power supply means 92. As explained above, the PLC 8 modulates broadcast signals received from a source 7 by use of a connection 70. In the example those broadcast signals correspond to another TV channel, Ch. 4.

The PLC 8 is configured to modulate the broadcast signals corresponding to channel Ch. 4 and transmit the modulated electric signals on the power lines 80 in such a way that the irradiated aerial signals 82 are irradiated in the surroundings of the power lines 80. In the example of FIG. 6, the power lines 80 are the very same power lines supplying power to the television 51. In an alternative, the television 51 is powered by other electric means.

The portion of cable 6 connected to the television 51 (i.e. the patch cord) is adapted to receive the irradiated aerial signals 82 and transmit induced signals, as described above with reference to FIG. 5. Therefore, the television 51 receives channels Ch. 1, Ch. 2 and Ch. 3 provided by the antenna 5 and the channel Ch. 4 provided by the PLC. Advantageously the PLC 8 is configured to modulate electric signals on the power lines 80 so that the irradiated aerial signals 82 do not interfere with the frequencies of the signals on the antenna cables 6. More precisely, the PLC 8 is configured to propagate irradiated aerial signals over frequencies not occupied but in any case receivable by the receiver of television 51.

Frequencies not occupied or available means a frequency where the existing signals are too low for being processed by a receiver. For example, frequencies where the average power level over a period of time is below a threshold are considered available.

According to an embodiment of the invention, the PLC 8 comprises a module for detecting frequencies available for the modulated signals. In another embodiment, the user manually configures the frequencies to be used, either by use of a user interface or by a setting a plurality of switches that affect the frequency distribution of the signals transformed by the PLC 8.

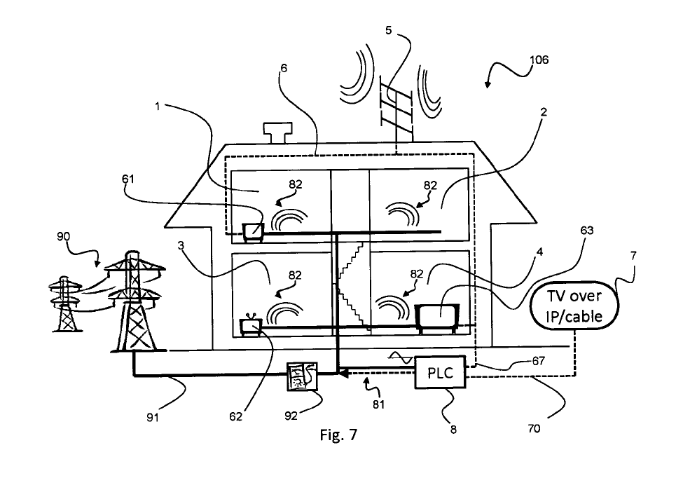

FIG. 7 schematically represents a building 106, in which transmission of broadcast signals is achieved through another embodiment of the method according to the present invention.

According to this embodiment, in addition to the elements described with reference to FIG. 5, a cable connection 67 between the antenna cables 6 and the PLC 8 is provided.

In this embodiment, the PLC 8 is further configured to detect the frequencies of the aerial signals by scanning the frequencies of signals received by the antenna 5. Accordingly, the PLC 8 is configured to automatically detect and select frequencies available for the irradiated aerial signals 82.

Advantageously, the PLC is further configured to combine the broadcast signals from the source 7 and the broadcast signals from the antenna 5. In such embodiment the irradiated aerial signals 82 comprise the broadcast signals received from the source 7 and additionally part or all of the broadcast signals received from antenna 5 and transmitted through cable 67. According to this embodiment, the aerial broadcast signals are replicated so that television 62 can receive the aerial broadcast signals trough the irradiated aerial signals 82, while televisions 61 and 63 receive a duplicate of the aerial broadcast signals, preferably on different frequencies, trough the irradiated aerial signals 82. The television 61 and 63 can then select the channel with best quality. In this case, a modification in the Logic Channel Numbering (LCN) of the television might be needed, according to known methods.

In an alternative embodiment, the irradiated aerial signals 82 comprise the aerial broadcast signals received from antenna 5, and are distributed on the same frequencies as the signals running on the antenna cables 6, in a synchronized manner. In this case, the strength of the signals received by the television 61 and 63 is further improved, since the signal power becomes greater.

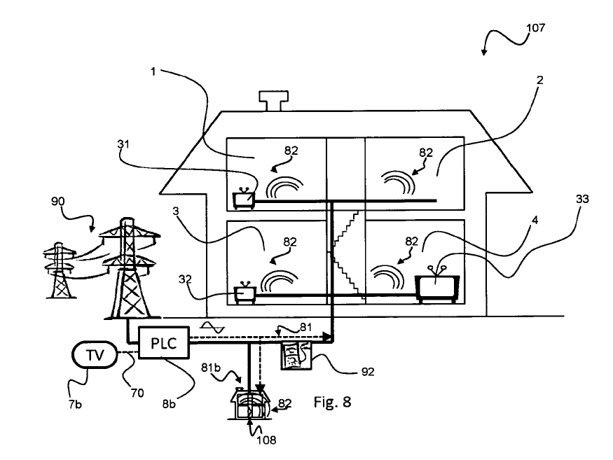

FIG. 8 schematically represents an environment for carrying out another embodiment of an environment for carrying out the method according to the present invention. Through a single PCL 8b located on the main power lines, a plurality of broadcast signals 81 and 81b can be transmitted over the power lines to reach a plurality of buildings 107 and 108. In this case, the broadcast signals of a preferred source 7b can be distributed to a plurality of buildings, without the need for dedicated transmission and broadcasting means such as antennas in each building. The irradiated aerial signals 82 will be the same for all buildings covered by a single PCL 8b, and will be received by the televisions therein located as described above.

The method described above allow distributing broadcast signals in an indoor environment, through a PCL device that modulates broadcast signals over the power lines in such a way that corresponding irradiated signals can be easily received by receivers such as televisions and set-top-boxes.

The invention provides an extension of the coverage area of a broadcast distibuter in environments covered by power lines, advantageously using a single PCL device.

The invention is applicable to existing transmission and reception systems, by providing additional modules embodying the present method. For example, a suitable PCL module can be used to implement the method, and such PCL module can be added to existing systems.

The method according to the invention, as merely exemplified in the present description, is susceptible of a number of changes and variants falling within the inventive concept as defined by the appended claims. All the implementing details given can be replaced by their known technical equivalents, without departing from the scope of the present invention.

In particular, although the invention has been described with reference to indoor environments, it is also applicable to certain outdoor environments provided with power lines and wherein additional reception of signals is desirable.

1. Method for distributing broadcast signals to an indoor environment, comprising the steps of:
receiving the broadcast signals;
transforming the received broadcast signals into electric signals by use of a Power Line Communication device;
transmitting said electric signals over power lines,
wherein said electric signals are modulated, said modulated electric signals being configured to be irradiated as aerial signals in the surrounding space of the power lines of the indoor environment, said irradiated aerial signals being adapted to be received with a receiver, and said receiver being adapted to demodulate the received irradiated aerial signals.

2. Method according to claim 1, wherein said electric signals are modulated with a COFDM scheme.

3. Method according to claim 1, wherein receiving said broadcast signals comprises receiving aerial signals over at least one frequency, and said irradiated aerial signals are configured to propagate over the same at least one frequency.

4. Method according to claim 1, further comprising configuring said Power Line Communication device so that the irradiated aerial signals are propagated on available frequencies.

5. Method according to claim 4, wherein said configuring of the Power Line Communication device comprises modification of the frequencies of transmission of the irradiated aerial signals by the user.

6. Method according to claim 4, wherein said configuring of the Power Line Communication device comprises an automatic determination of the frequencies of transmission by said Power Line Communication device.

7. Method according to claim 1, wherein receiving said irradiated aerial signals comprises receiving said irradiated aerial signals through an air interface antenna connected to the receiver.

8. Method according to claim 1, wherein receiving said irradiated aerial signals comprises receiving said irradiated aerial signals on a cable connected to the receiver and generating on said cable induced signals corresponding to the irradiated aerial signals.

9. Method according to claim 8, wherein said cable carries other broadcast signals to the receiver and the method comprises separating said other broadcast signals from said induced signals.

10. Method according to claim 8, wherein said cable carries the same broadcast signals to the receiver and the method comprises synchronizing the transmission of the modulated electric signals and the reception of the broadcast signals on said cable and generating the irradiated aerial signals in such way that they are added to the broadcast signals on said cable.

11. System for distributing broadcast signals to an indoor environment, comprising:
at least one source of broadcast signals;
a Power Line Communication device connected to said at least one source of broadcast signals;
power lines connected to said Power Line Communication device; and
receivers in the vicinity of said power lines;
wherein the Power Line Communication device is configured for transforming and transmitting on the power lines modulated electric signals corresponding to said broadcast signals, said modulated electric signals being configured to be irradiated in the surrounding space of the power lines as aerial signals; and
wherein the receivers are configured to receive and demodulate said irradiated aerial signals.

12. System configured for carrying out the method of claim 1.

13. Method for distributing broadcast signals to an indoor environment, carried out in a Power Line Communication device and comprising the steps of:
receiving broadcast signals from at least one source;
transforming the received broadcast signals into electric signals;
transmitting said electric signals over power lines,
wherein said electric signals are modulated, said modulated electric signals being configured to be irradiated as aerial signals in the surrounding space of the power lines, said irradiated aerial signals being adapted to be received and demodulated by a receiver.

14. Method for distributing broadcast signals to an indoor environment, carried out in a Power Line Communication device, according to claim 13, wherein said electric signals are modulated with a COFDM scheme.

15. Power Line Communication device comprising:
a receiver of broadcast signals from at least one source;
a modulator for transforming the received broadcast signals into modulated electric signals;
a transmitter for transmitting the modulated electric signals to power lines;
wherein the Power Line Communication device is configured for transforming and transmitting the modulated electric signals in such a way to irradiate aerial signals in the surrounding space of the power lines being adapted to be received and demodulated.
